(19) United States
(12) Patent Application Publication
(10) Pub. No.: US 2023/0239216 A1
(43) Pub. Date: Jul. 27, 2023

(54) COMMUNICATION DEVICE SETTING MANAGEMENT DEVICE, COMMUNICATION DEVICE SETTING MANAGEMENT METHOD AND PROGRAM

(71) Applicant: NIPPON TELEGRAPH AND TELEPHONE CORPORATION, Tokyo (JP)

(72) Inventors: Sei KOU, Musashino-shi, Tokyo (JP); Tomoya HATANO, Musashino-shi, Tokyo (JP)

(73) Assignee: NIPPON TELEGRAPH AND TELEPHONE CORPORATION, Tokyo (JP)

(21) Appl. No.: 17/928,701

(22) PCT Filed: Jun. 5, 2020
(86) PCT No.: PCT/JP2020/022386

§ 371 Date: Nov. 30, 2022

(51) Int. Cl. H04L 41/12

(52) U.S. Cl. CPC H04L 41/12

(57) ABSTRACT

A topology detection unit (11) detects a physical connection status between adjacent devices (A, C) and a replaced device group (B) as a first topology and detects a physical connection status between the adjacent devices (A, C) and a replacement device group (D) as a second topology. A setting information acquisition unit (13) acquires setting information of each of the adjacent devices (A, C) and the replaced device group (B). A replaced-device-group information arrangement unit (14) uses the first topology to extract the setting information of each of the adjacent devices (A, C) related to the setting information of the replaced device group (B). A configuration generation unit (15) generates the configuration of the replacement device group (D), the configuration adapting to the second topology, based on the extracted setting information of each of the adjacent devices (A, C) The configuration setting unit (16) sets the generated configuration in the replacement device group (D).

### TECHNICAL FIELD

The present disclosure relates to a communication device setting control apparatus, a communication device setting control method, and a program, capable of automatically performing a configuration setting in collective replacement of a communication device group.

### BACKGROUND ART

In a network, a communication device is replaced in the case of the failure or end-of-life (EOL) of the communication device, collective replacement (migration) of communication devices to a next network, or the like (e.g., see Non-Patent Literature 1). It is necessary to newly set a configuration for a replacement communication device. As a conventional technique, there has been proposed a network device setting apparatus for performing a device setting when a network device constituting a ring topology is newly installed or replaced (e.g., see Patent Literature 1). With this apparatus, it is possible to automatically generate and set the configuration of the replacement communication device from routing information and the like.

### CITATION LIST

### Patent Literature

Patent Literature 1: Japanese Laid-Open Patent Publication No. 2013-207316

### Non-Patent Literature

Non-Patent Literature 1: Minakuchi et al., “Recommendation of Network Operation Automation”, JANOG29 Meeting, January 2012 [search date: May 25, 2020], Internet <URL: https://www.janog.gr.jp/meeting/janog29/_downloads/janog29-auto-after-mizuguchi-01.pdf>

### SUMMARY OF THE INVENTION

### Technical Problem

However, the conventional technique cannot be applied to the device replacement except for that in the ring network and cannot be applied to the collective replacement of a communication device group made up of a plurality of communication devices. Therefore, there has been a problem that a maintenance person has to manually generate and set a configuration of each of a plurality of replacement communication devices.

The present disclosure has been made in order to solve the problem as described above, and an object of the present disclosure is to obtain a communication device setting control apparatus, a communication device setting control method, and a program, capable of automatically performing a configuration setting in collective replacement of a communication device group.

### Means for Solving the Problem

A communication device setting control apparatus according to the present disclosure is a communication device setting control apparatus for setting a configuration of a replacement device group when a replaced device group connected to an adjacent device is replaced with the replacement device group, the apparatus including: a topology detection unit that detects a physical connection status between the adjacent device and the replaced device group as a first topology and detects a physical connection status between the adjacent device and the replacement device group as a second topology; a setting information acquisition unit that acquires setting information of the adjacent device and the replaced device group; a replaced-device-group information arrangement unit that uses the first topology to extract the setting information of the adjacent device related to the setting information of the replaced device group; a configuration generation unit that generates the configuration of the replacement device group, the configuration adapting to the second topology, based on the extracted setting information of the adjacent device; and a configuration setting unit that sets the generated configuration to the replacement device group.

### Effects of the Invention

According to the present disclosure, it is possible to automatically perform the configuration setting in the collective replacement of the communication device group.

### BRIEF DESCRIPTION OF DRAWINGS

FIG. 1 is a diagram showing a communication device setting control apparatus according to an embodiment.

FIG. 2 is a diagram showing a replacement pattern of communication devices.

FIG. 3 is a diagram showing a replacement pattern of communication devices.

FIG. 4 is a diagram showing a replacement pattern of communication devices.

FIG. 5 is a diagram showing a replacement pattern of communication devices.

FIG. 6 is a diagram showing a replacement pattern of communication devices.

FIG. 7 is a diagram showing a replacement pattern of communication devices according to the embodiment.

FIG. 8 is a flowchart for an operation of the communication device setting control apparatus according to the embodiment.

FIG. 9 is a flowchart for an operation of a topology detection unit.

FIG. 10 is a diagram showings examples of topology databases.

FIG. 11 is a flowchart for an operation of a setting information acquisition unit.

FIG. 12 is a diagram showing examples of first and second setting information databases.

FIG. 13 is a flowchart for an operation of a replaced-device-group information arrangement unit.

FIG. 14 is a diagram for explaining the operation of the replaced-device-group information arrangement unit.

FIG. 15 is a diagram for explaining an operation of a replacement-device-group path determination unit.

FIG. 16 is a diagram for explaining an operation of a configuration generation unit.

FIG. 17 is a flowchart for changing the setting of the communication device.

### DESCRIPTION OF EMBODIMENTS

A communication device setting control apparatus, a communication device setting control method, and a program according to an embodiment will be described below with reference to the drawings.

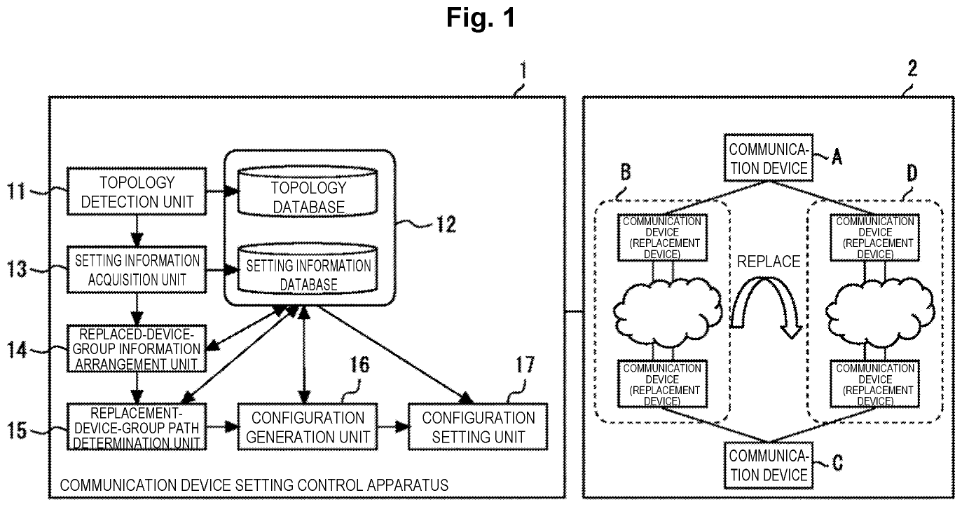

FIG. 1 is a diagram showing a communication device setting control apparatus according to an embodiment. A communication device setting control apparatus 1 controls a communication setting of a communication device 2 for data transfer. The communication device setting control apparatus 1 may be directly connected to the communication device 2 or may be connected to the communication device 2 via a network.

The communication device 2 is a relay device or the like constituting a network, such as a switch or a router. A replaced device group B is connected in series to adjacent devices A, C. It is assumed here that the replaced device group B is replaced with the replacement device group D. Each of the replaced device group B and the replacement device group D has a plurality of communication devices connected in series.

The communication device setting control apparatus 1 includes a topology detection unit 11, a recording unit 12, a setting information acquisition unit 13, a replaced-device-group information arrangement unit 14, a replacement-device-group path determination unit 15, a configuration generation unit 16, and a configuration setting unit 17.

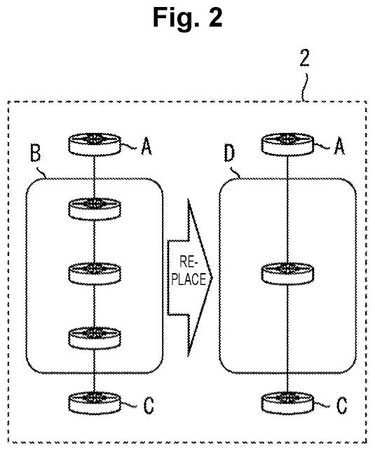

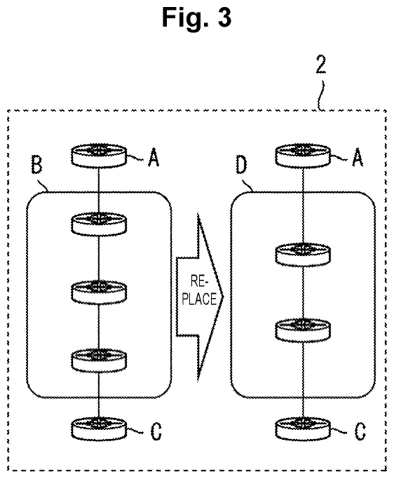

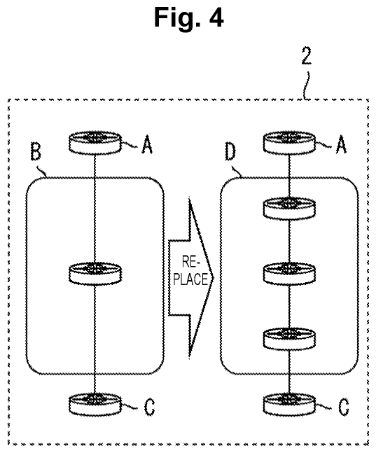

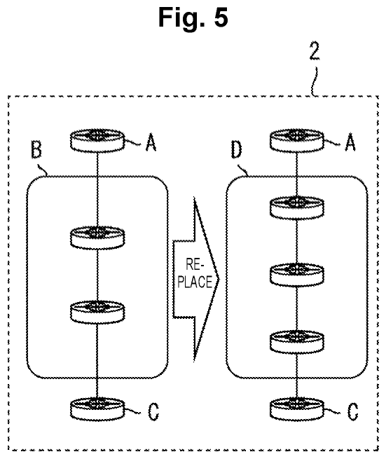

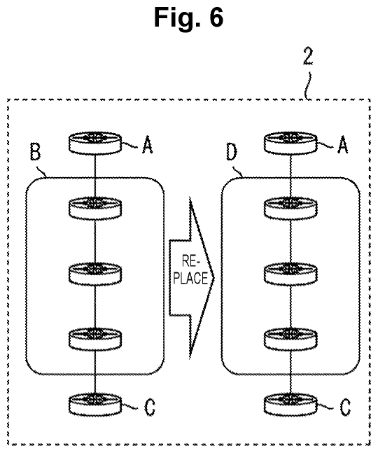

FIGS. 2 to 6 are diagrams each showing a replacement pattern of communication devices. In FIG. 2, the number of replaced devices is three, and the number of replacement devices is one. In FIG. 3, the number of replaced devices is three, and the number of replacement devices is two. In FIG. 4, the number of replaced devices is one, and the number of replacement devices is three. In FIG. 5, the number of replaced devices is two, and the number of replacement devices is three. In FIG. 6, the number of replaced devices is three, and the number of replacement devices is three. As thus described, various replacement patterns are applied according to the application. For example, when the number of unnecessary bases (communication devices) is reduced due to the extension of transfer, a replacement pattern with the number of replacement devices reduced from the number of replaced devices is applied.

Even when the replaced device group B and the replacement device group D are different or the same in the number of devices, the communication device setting control apparatus 1 automatically performs a configuration setting for collective replacement of a plurality of communication devices in a state where the connection of the physical cables between the adjacent devices A, C and the replacement device group D is completed. The communication device setting control apparatus 1 can correspond to all the patterns shown in FIGS. 2 to 6. The operation of the communication device setting control apparatus 1 will be described in detail below with reference to the replacement pattern shown in FIG. 3.

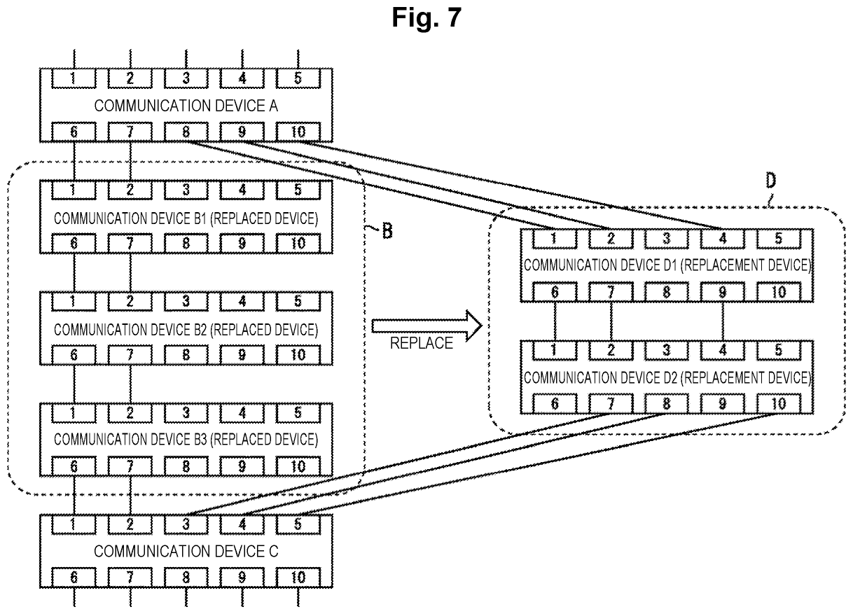

FIG. 7 is a diagram showing a replacement pattern of the communication device according to the embodiment. It is assumed that replaced device group B1, B2, B3 having three communication devices connected in series is collectively replaced (migrated) with replacement device group D1, D2 having two communication devices connected in series. An operator connects the adjacent devices A, C and the replacement device group D1, D2 by physical cables.

In the past, an operator designed a connection diagram of physical cables in advance, created setting information, and then proceeded with replacement work. On the other hand, in the present embodiment, the communication device setting control apparatus 1 can automatically generate setting information and complete replacement work. Therefore, the operator may connect a predetermined number of physical cables connecting communication devices in series to any port. However, the number of connections (bands) between the replacement devices in the replacement device group D1, D2 needs to be made equal to or greater than the number of connections (bands) among the replaced devices in the replaced device group B1, B2, B3 in view of the amount of traffic and the like. Here, the number of physical cables connecting between the adjacent device A and the communication device D1, between the communication device D1 and the communication device D2, and between the communication device D2 and the adjacent device C is three. It is assumed that the communication speeds of the ports of the replacement device group D1, D2 are the same.

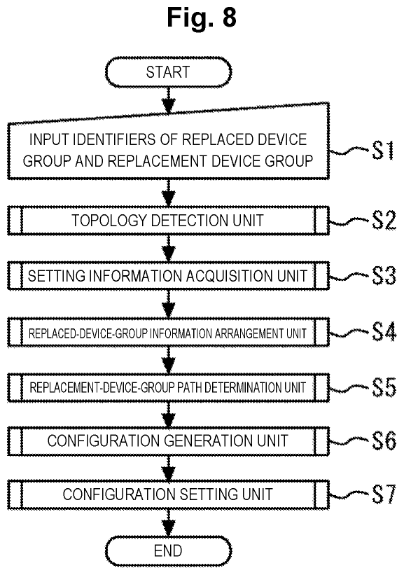

FIG. 8 is a flowchart for the operation of the communication device setting control apparatus according to the embodiment. In the starting state, the connection of the physical cables to the replacement device group D1, D2 is completed. The communication device setting control apparatus 1 is in a state of waiting for the operator to input the identifiers of the replaced device group B1, B2, B3 and the replacement device group D1, D2. The identifier may be a fixed identification (ID) or an internet protocol (IP) address of the communication device or an ID that the operator adds to the communication device in a database.

Next, the operator inputs the identifiers of the replaced device group B1, B2, B3 and the replacement device group D1, D2 (step S1). In response to this, the topology detection unit 11 of the communication device setting control apparatus 1 detects the topology (physical connection status) of the communication device 2 controlled by the communication device setting control apparatus 1 (step S2).

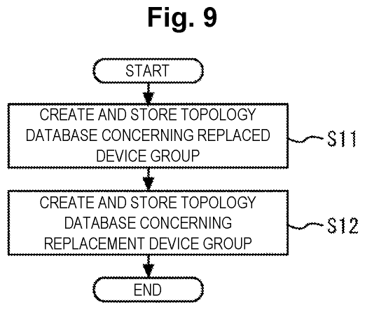

FIG. 9 is a flowchart for the operation of the topology detection unit. The topology detection unit 11 detects a physical connection status between the adjacent devices A, C and the replaced device group B1, B2, B3 as a first topology, creates a topology database DB-t1, and stores the database into the recording unit 12 (step S11). Next, the topology detection unit 11 detects a physical connection status between the adjacent devices A, C and the replacement device group D1, D2 as a second topology, creates a topology database DB-t2, and stores the database into the recording unit 12 (step S12).

For example, the topology detection unit 11 detects a topology by transmitting and receiving a Link Layer Discovery Protocol (LLDP) packet to and from each communication device and collecting the information of each of the connected adjacent devices. Note that LLDP is a protocol for periodically notifying an adjacent device of information on one's own device and collecting information from the adjacent device. The use of LLDP can make it easy to see the information of each of the connected adjacent devices without having to log in to the adjacent devices. For devices that do not support LLDP, the operator may register a topology in advance.

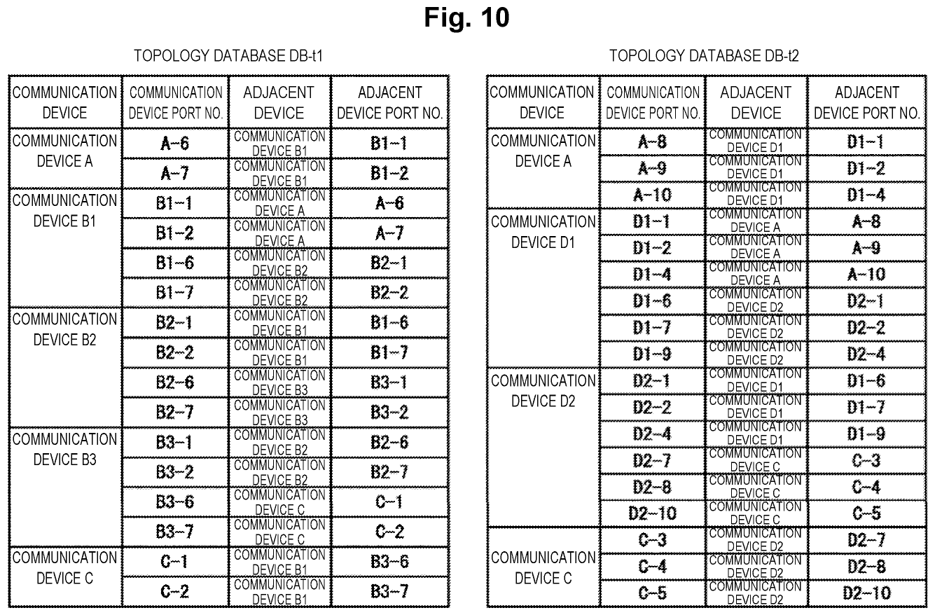

FIG. 10 shows examples of the topology databases. A port number used by each communication device and a port number of an adjacent device connected thereto are recorded.

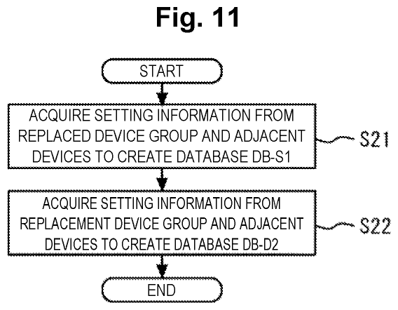

Next, the setting information acquisition unit 13 acquires setting information of each communication device (step S3). FIG. 11 is a flowchart for the operation of the setting information acquisition unit. First, the setting information acquisition unit 13 acquires setting information from each of the replaced device group B1, B2, B3 and the adjacent devices A, C, creates a setting information database DB-S1 concerning the replaced device group B1, B2, B3, and stores the database into the recording unit 12 (step S21). Next, the setting information acquisition unit 13 acquires the setting information from each of the replacement device group D1, D2 and the adjacent devices A, C, creates a setting information database DB-D2 concerning the replacement device group D1, D2, and stores the database into the recording unit 12 (step S22).

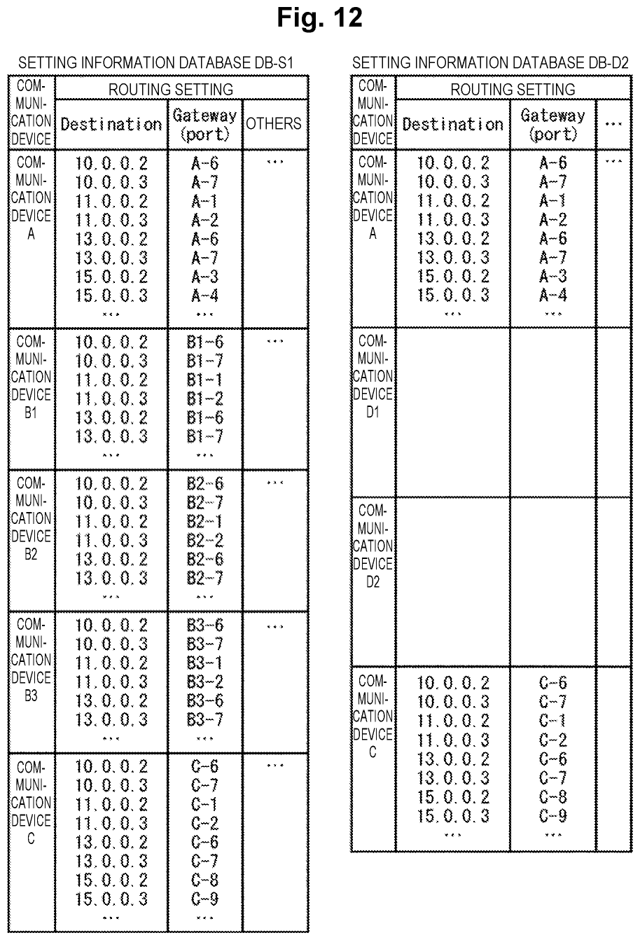

FIG. 12 shows examples of the first and second setting information databases. Setting information, such as a port number (Gateway (port)), a destination IP address (Destination), and a physical communication speed used by each communication device, is registered in these setting information databases. There is a routing setting as the setting information. Here, forwarding based on an IP address of Layer-3 (L3), such as an L3 switch or router, is used. There is also a case of using a layer-2 (L2) switch for forwarding based on a media access control (MAC) address.

Simple Network Management Protocol (SNMP) may be used for the acquisition of setting information by the setting information acquisition unit 13. Note that SNMP is an application layer protocol for monitoring and controlling a communication device connected to a network via the network. It is assumed that a setting information part in the setting information database is registered in advance by the operator in accordance with the specification of a network to be realized.

In the setting information database DB-D2 concerning the replacement device group D1, D2, the original information is used for the setting information of each of the adjacent devices A, C. The setting information of the replacement device group D1, D2 has not yet been registered.

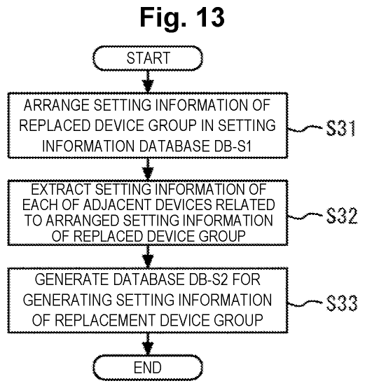

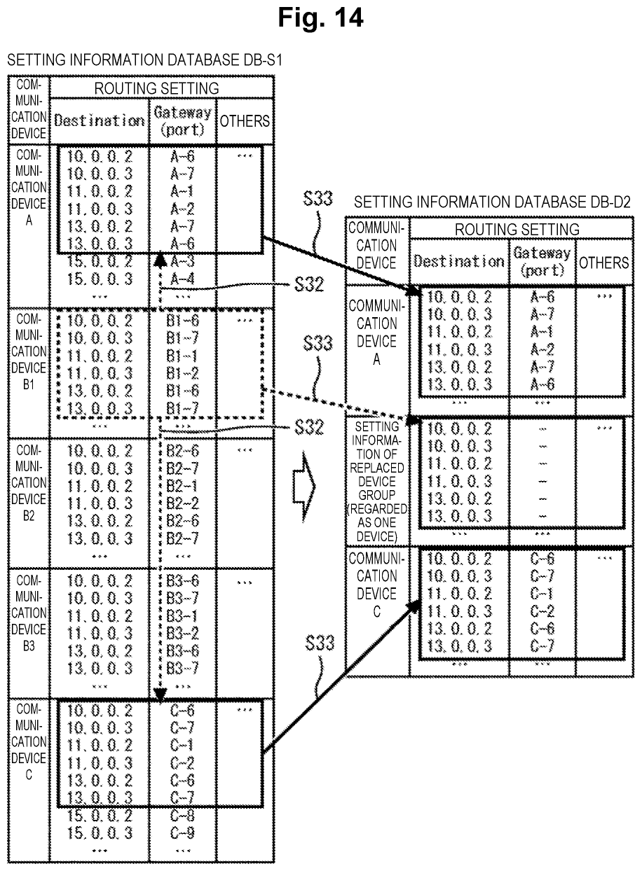

Next, the replaced-device-group information arrangement unit 14 arranges the setting information of the replaced device group B1, B2, B3 (step S4). FIG. 13 is a flowchart for the operation of the replaced-device-group information arrangement unit. FIG. 14 is a diagram for explaining the operation of the replaced-device-group information arrangement unit. First, the replaced-device-group information arrangement unit 14 uses identifiers to arrange the setting information of the replaced device group B1, B2, B3 in the setting information database DB-S1 (step S31). In the case of the L3 base, the routing setting (setting information) of the replaced device group B1, B2, B3 is arranged using a destination IP address (Destination) as the identifier. Here, one replaced device of the replaced device group B1, B2, B3 is selected, and routing is differentiated using the destination IP address. The setting information of each replaced device of the replaced device group B1, B2, B3 is different in the setting of Gateway (port) and the like but is common in the information of the destination IP address and the like of the passing communication packet. In the case of L2, the setting information is arranged using a destination MAC address or the like as the identifier.

Next, the routing setting information of each of the adjacent devices A, C is searched using the topology and setting information of the replaced device group B1, B2, B3, and the setting information of each of the adjacent devices A, C related to the arranged setting information of the replaced device group B1, B2, B3 is extracted (step S32). Specifically, the setting information of each of the adjacent devices A, C using the same destination IP address as the setting information of the replaced device group B1, B2, B3 is extracted.

Finally, based on the extracted setting information, a database DB-S2 for generating the setting information of the replacement device group D1, D2 is generated (step S33). In the database DB-S2, the replaced device group B1, B2, B3 is regarded as one device, the Gateway (port) part in the routing setting is left blank, and other information is acquired from the setting information database DB-S1 of the replaced device group. The adjacent devices A, C parts in the database DB-S2 are filled with the routing settings extracted in step S32.

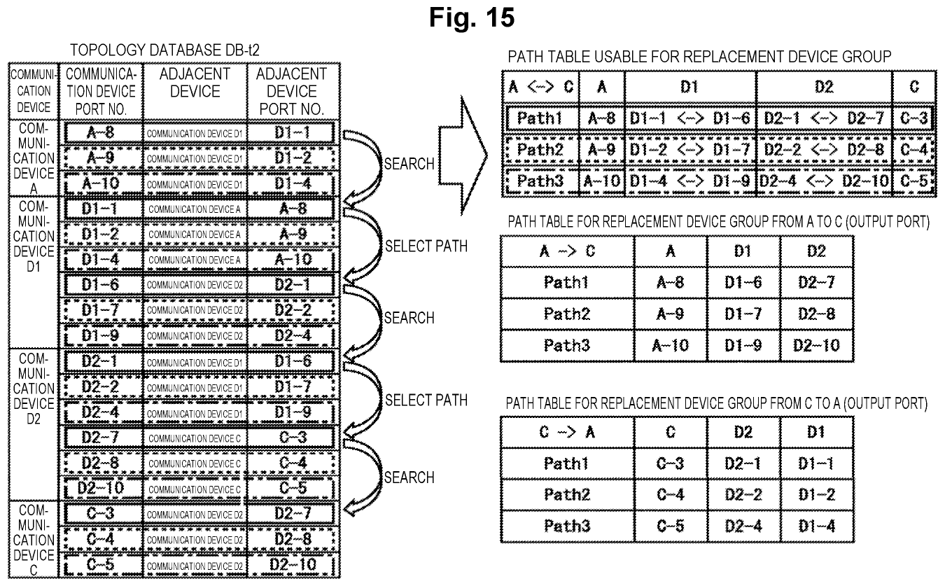

Next, the replacement-device-group path determination unit 15 determines the paths of the replacement device group D1, D2 (step S5). FIG. 15 is a diagram for explaining the operation of the replacement-device-group path determination unit. The replacement-device-group path determination unit 15 uses adjacent information of each of ports from the adjacent device A to the adjacent device C in the topology database DB-t2 of the replacement device group to create a path table usable as a packet forwarding path.

As an example, a method of creating Path1 will be described. First, when the adjacent information of port A-8 of the adjacent device A is searched, the adjacent port is found to be port D1-1. Next, when the adjacent information of port D1-1 of the communication device D1 is searched, the adjacent port is found to be port A-8. With the matching of the adjacent information, a first path between the adjacent device A and the communication device D1 is determined to be A-8 and D1-1. Next, when a path between the communication device D1 and the communication device D2 is searched, a first starting path is found to be a path between port D1-6 and port D2-1. Next, when the adjacent information of port D2-1 of the communication device D2 is searched, the adjacent port is found to be port D1-6. With the matching of the adjacent information, the first path between the communication device D1 and the communication device D2 is determined to be D1-6 and D2-1. When a search is made in this manner to the adjacent device C, Path1 is determined. Note that the adjacent information matched in the search is deleted and is not used in the next search. Path2 and Path3 can be created in the same manner as Path1.

There are packets forwarded in the order of A, D1, D2, and C, and packets forwarded in the order of C, D2, D1, and A. Therefore, a path table from A to C for the replacement communication devices and a path table from C to A for the replacement communication devices are created. For example, in Path1 of the path table from A to C, the packet starts from port A-8 of the adjacent device A and reaches the adjacent device C via port D1-6 of the communication device D1 and port D2-7 of the communication device D2.

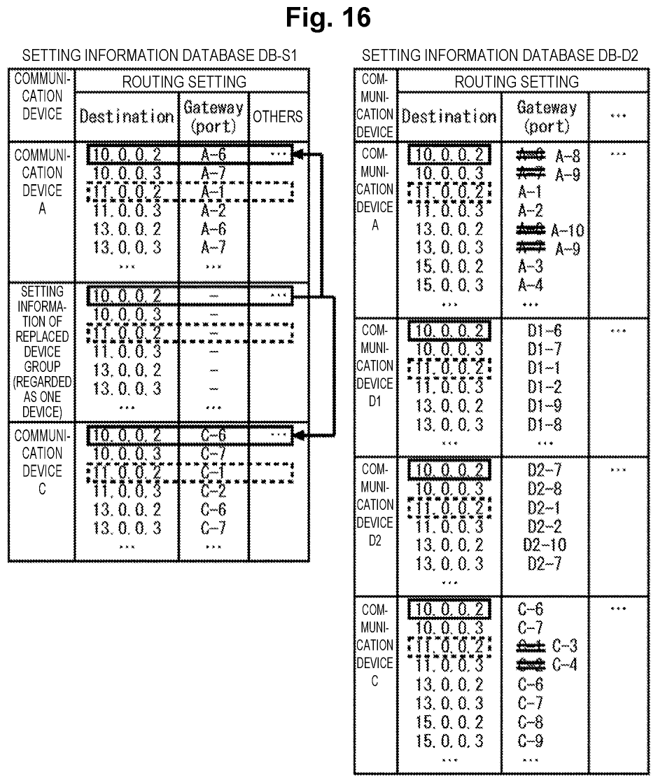

Next, the configuration generation unit 16 generates a configuration (setting information) of the replacement device group D1, D2 (step S6). FIG. 16 is a diagram for explaining the operation of the configuration generation unit. First, the configuration generation unit 16 sequentially checks the routing setting of the replaced device group B1, B2, B3 in the database DB-S2 and refers to the destination IP address (Destination) to find a part that matches the routing setting of each of the adjacent devices A, C. Thus, the setting information for one packet can be grasped. The Gateway (port) information of the routing setting of each of the adjacent devices A, C in the matching part is acquired, and it is determined whether the path is a path from A to C or a path from C to A. For example, when the destination IP address is 10.0.0.2, a path starts from port A-6 of the adjacent device A and is thus found to be the path from A to C.

Next, a path table to be used is selected based on the direction of the path. For example, when the destination IP address is 10.0.0.2, Path1 in the path table from A to C in FIG. 15 is used. Then, the setting information in the setting information database DB-D2 is modified in the order of the path. Since the starting point of Path1 is A-8, the Gateway (port) of the adjacent device A in the setting information database DB-D2 is modified from A-6 to A-8.

Since the next port of Path1 is D1-6, the Gateway (port) of the routing setting of 10.0.0.2 in the setting information of the database DB-S2 is rewritten to D1-6 and added to the communication device D1 part in DB-D2. Similarly, since the next port of Path1 is D2-7, the routing setting is added to the communication device D2 part in DB-D2. There is no need to modify the adjacent device C part. This brings to an end the modification and generation of the setting for Path1. When the destination IP address is 11.0.0.2, the path is determined to be the path from C to A, and the setting information is modified and generated in the same manner. As described above, the setting information of the replacement device group D1, D2 is generated so as to adapt to the topology of the replacement device group, and the setting information of each of the adjacent devices A, C is modified.

In the above example, round-robin has been used at the time of assigning paths, but an assignment method based on a delay or a band may be used. As thus described, the setting information of the replaced device group in DB-S2 is sequentially used to create the updated setting information database DB-D2.

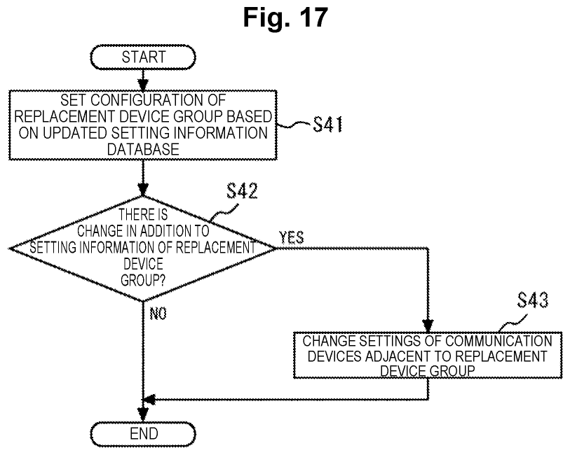

Next, the configuration setting unit 17 sets the generated configuration in the replacement device group D1, D2 (step S7). FIG. 17 is a flowchart for changing the setting of the communication device. First, the configuration of the replacement device group D1, D2 is set based on the updated setting information database DB-D2 (step S41). Here, the setting information (routing setting) of each of the communication devices D1 and D2 is set. At that time, Secure Shell (SSH), Telnet, or OpenFlow, which represents software-defined networking (SDN), may be used. An automatic setting tool such as Ansible may be used to realize the automation of the setting.

Next, it is checked whether or not there is a change in the setting information of each of the adjacent devices A, C adjacent to the replacement device group D1, D2 in addition to the setting information of the replacement device group D1, D2 (step S42). When there is no change, the configuration setting unit 17 terminates the operation. When there is a change, the configuration setting unit 17 changes the setting information of each of the adjacent devices A, C and then terminates the operation. This brings to an end all the operations of the communication device setting control apparatus, thus completing the replacement work.

As described above, in the present embodiment, the topology for the adjacent devices and the replaced device group is used to extract the setting information of each of the adjacent devices related to the setting information of the replaced device group, and based on the extracted setting information, a configuration of the replacement device group which adapts to the topology for the adjacent devices and the replacement device group is generated and set. As a result, even when a plurality of communication devices are collectively replaced with communication devices different in number, it is possible to automatically perform the configuration setting of each communication device. Hence it is not necessary for the operator to design a port to be wired in advance. Therefore, at the time of connecting between the replacement communication device and the adjacent device, it is not necessary to connect to a specific port, but it is only necessary to connect to an arbitrary port with a necessary number of physical cables. Thus, the burden on the operator can be reduced.

At least a part of the communication device setting control apparatus according to the embodiment described above may be realized by a computer. In this case, a program for realizing this function may be recorded on a computer-readable recording medium, and the program recorded on the recording medium may be read by a computer system and executed, thereby leading to the realization. Note that the term “computer system” as used herein includes hardware such as an operating system (OS) and peripheral devices. The term “computer-readable recording medium” refers to a portable medium such as a flexible disk, a magneto-optical disk, a read-only memory (ROM), or a compact disc (CD)-ROM, or a storage device such as a hard disk incorporated in the computer system. Further, the term “computer-readable recording medium” may include a medium that dynamically holds a program for a short period of time, such as a communication line in the case of transmitting a program via a network like the Internet or a communication line like a telephone line, and a medium that holds a program for a fixed period of time, such as a volatile memory in the computer system serving as a server or a client in such a case. The above program may be a program for realizing a part of the function described above, may be a program that can be realized by combining the function described above with a program already recorded in the computer system, or may be a program that is realized using a programmable logic device such as a field-programmable gate array (FPGA).

### REFERENCE SIGNS LIST

A, C Adjacent device
B1, B2, B3 Replaced device group
D1, D2 Replacement device group
11 Topology detection unit
12 Recording unit
13 Setting information acquisition unit
14 Replaced-device-group information arrangement unit
15 Replacement-device-group path determination unit
16 Configuration generation unit
17 Configuration setting unit

1. A communication device setting control apparatus for setting a configuration of a replacement device group when a replaced device group connected to an adjacent device is replaced with the replacement device group, the apparatus comprising:
a processor; and
a storage medium having computer program instructions stored thereon, when executed by the processor, perform to:
detects a physical connection status between the adjacent device and the replaced device group as a first topology and detects a physical connection status between the adjacent device and the replacement device group as a second topology;
acquires setting information of the adjacent device and the replaced device group;
uses the first topology to extract the setting information of the adjacent device related to the setting information of the replaced device group;
generates the configuration of the replacement device group, the configuration adapting to the second topology, based on the extracted setting information; and
sets the generated configuration in the replacement device group.

2. The communication device setting control apparatus according to claim 1, wherein the computer program instructions further uses the second topology to create a path table usable as a packet forwarding path, and uses the path table to generate the configuration of the replacement device group.

3. The communication device setting control apparatus according to claim 1, wherein the computer program instructions further perform to extracts the setting information of the adjacent device using the same identifier as the setting information of the replaced device group.

4. The communication device setting control apparatus according to claim 3, wherein the identifier is a destination internet protocol (IP) address or a destination media access control (MAC) address.

5. The communication device setting control apparatus according to claim 1, wherein the computer program instructions further perform to modifies the setting information of the adjacent device so as to adapt to the second topology.

6. A communication device setting control method for a communication device setting control apparatus setting a configuration of a replacement device group when a replaced device group connected to an adjacent device is replaced with the replacement device group, the method comprising the steps of:
detecting a physical connection status between the adjacent device and the replaced device group as a first topology and detecting a physical connection status between the adjacent device and the replacement device group as a second topology;
acquiring setting information of the adjacent device and the replaced device group;
using the first topology to extract the setting information of the adjacent device related to the setting information of the replaced device group;
generating the configuration of the replacement device group, the configuration adapting to the second topology, based on the extracted setting information of the adjacent device; and
setting the generated configuration in the replacement device group.

7. A non-transitory computer-readable medium having computer-executable instructions that, upon execution of the instructions by a processor of a computer, cause the computer to function as the communication device setting control apparatus according to claim 1.
